(19) United States
(12) Patent Application Publication
(10) Pub. No.: US 2026/0178441 A1
(43) Pub. Date: Jun. 25, 2026

(54) DATA STORAGE DEVICE CAPABLE OF RECOVERING ERROR DATA AND METHOD OF OPERATING THE SAME

(71) Applicant: SK hynix Inc., Icheon-si (KR)

(72) Inventor: Se Joong KIM, Icheon-si (KR)

(21) Appl. No.: 19/196,028

(22) Filed: May 1, 2025

(30) Foreign Application Priority Data
Dec. 20, 2024 (KR) 10-2024-0192653

(51) Int. Cl. G06F 11/10

(52) U.S. Cl. CPC G06F 11/1044

(57) ABSTRACT

A data storage device may include a memory device and a controller. The controller may divide a block group including a plurality of memory blocks into a set number of sub-groups, the sub-groups including first and second sub-groups, each of the sub-groups including a plurality of pages. The controller may generate first recovery data programed on a page basis to correspond to data programmed in the first sub-group on the page basis, generate second recovery data programed on a sub-group basis for the first sub-group when programming of the first sub-group is complete. The second sub-group is programmed after the programming of the first sub-group is complete. The controller may invalidate the second recovery data for the first sub-group when programming of the second sub-group is complete.

### CROSS-REFERENCES TO RELATED APPLICATION

The present application claims priority under 35 U.S.C. § 119(a) to Korean patent application number 10-2024-0192653, filed on Dec. 20, 2024, in the Korean Intellectual Property Office, which is incorporated herein by reference in its entirety.

### BACKGROUND

### 1. Technical Field

Embodiments of the present disclosure relate to a semiconductor integrated device, and more specifically to a data storage device capable of recovering error data and a method of operating the data storage device.

### 2. Related Art

The data storage device may be connected to an external device to perform data input and output operations according to requests of the external device. A non-volatile storage media (e.g., a flash memory device) for data storage devices may have a limited number of erase-write cycles, which may affect integrity of data.

Various techniques may be researched to prevent data loss due to disturbances or unexpected power outages. For example, error correction circuits may be used to encode data before programming the data into a flash memory device, to store the encoded data together, and to decode the data read from the flash memory device.

It may be desirable to overcome error correction limitations of the error correction circuit.

### SUMMARY

According to example embodiments, there may be provide a data storage device. The data storage device may comprise a memory device including a plurality of memory blocks; and a controller configured to control the memory device. The controller divides a block group including the memory blocks into a set number of sub-groups, the sub-groups including first and second sub-groups, each of the sub-groups including a plurality of pages. Wherein the controller generates first recovery data programed on a page basis to correspond to data programmed in the first sub-group on the page basis, generates second recovery data programed on a sub-group basis for the first sub-group when programming of the first sub-group is complete, and invalidates the second recovery data for the first sub-group when programming of the second sub-group is complete, the second sub-group being programmed after the programming of the first sub-group is complete.

According to example embodiments, there may be provided a data storage device. The data storage device may include a memory device and a controller. The memory device may include a block group. The block group includes a plurality of sub-groups, the plurality of sub-groups including first and second sub-groups. The controller may generate first recovery data in unit as data may be programmed into the sub-groups. The controller may generate first recovery data programmed based on a unit to correspond to data programmed in the first sub-group based on the unit, generate second recovery data for the first sub-group when programming of the first sub-group is complete, and to invalidate the second recovery data for the first sub-group when programming of the second sub-group is complete, the second sub-group being programmed after the programming of the first sub-group is complete.

According to example embodiments, there may be provided a method of operating a data storage device. The data storage device may include a plurality of memory blocks, a block group with the plurality of memory blocks includes a set number of sub-groups, the sub-groups includes first and second sub-groups, each of the sub-groups including a plurality of pages. The controller may control the memory device. In the method of operating the data storage device, the controller may divide a block group including the plurality of memory blocks into a set number of sub-groups. The controller may generate first recovery data programmed on a page basis of to correspond to data programmed in the first sub-group, generate second recovery data programmed on a sub-group basis for the first sub-group when programming of the first sub-group is complete, and invalidate the second recovery data for the first sub-group when programming of the second sub-group is complete, the second sub-group being programmed after the programming of the first sub-group is complete.

According to example embodiments, multiple data sets for recovering errors may be generated and managed to recover the errors in user data even if the data for recovery may be partially lost.

### BRIEF DESCRIPTION OF THE DRAWINGS

Various aspects, features and beneficial aspects of subject matters of the present disclosure will be understood from the following detailed description taken in conjunction with the accompanying drawings, in which:

FIG. 1 is a block diagram illustrating a data processing system in accordance with embodiments;

FIG. 2 is a block diagram illustrating a non-volatile memory device in accordance with embodiments;

FIG. 3 is a view illustrating a data management concept for recovery based on data storage levels in accordance with embodiments;

FIG. 4 is a block diagram illustrating a recovery data manager in accordance with embodiments;

FIGS. 5 and 6 are conceptual views illustrating a method of managing data for recovery in accordance with embodiments; and

FIG. 7 is a flow chart illustrating a method of operating a data storage device in accordance with embodiments.

### DETAILED DESCRIPTION

Some embodiments of the present disclosure will now be described in more detail with reference to the accompanying drawings.

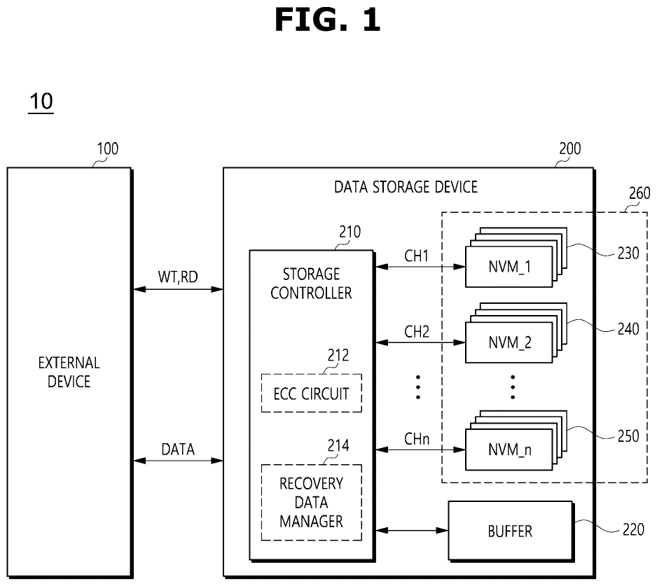

FIG. 1 is a block diagram illustrating a data processing system in accordance with example embodiments.

Referring to FIG. 1, a data processing system 10 may include an external device 100 and a data storage device 200.

The external device 100 may include at least one processor. For example, the external device 100 may be a processor, or an electronic device, or a system including a processor.

The data storage device 200 may include a controller 210, a buffer memory device (Buffer) 220 and a storage medium 260. The storage medium 260 may include at least a plurality of non-volatile memory devices 230, 240, and 250 in communication with the controller 210 via a plurality of channels (CH1, CH2, . . . , CHn). Although not shown in FIG. 1, one or more of the plurality of non-volatile memory devices 230, 240, and 250 may be classified into a first memory region where user data may be stored, and a second memory region where data for recovery may be stored. The data for recovery may be temporarily stored in the second memory region and then backed up to the first memory region.

The external device 100 may transmit a write request WT including a write command, an address, and write data to the data storage device 200 to record the data. In response, the data storage device 200 may control the storage medium 260 to program the write data.

The external device 100 may transmit a read request RD including a read command and an address to the data storage device 200 to read the data. The data storage device 200 may read the requested data from the storage medium 260 and transmit the data to the external device 100. The data storage device 200 may program data into or read data from the storage medium 260 to perform internal operations, in addition to the read request RD from the external device 100. The internal operations may include housekeeping operations such as garbage, wear-leveling, etc.

The buffer memory device 220 may temporarily store data transmitted to and from the controller 210 and the data storage device 200 during write or read operations. In some embodiments, the data storage device 200 may be a DRAM-less device that may not include the buffer memory device 220.

The controller 210 may provide an interface between the external device 100 and the data storage device 200. The controller 210 may include an ECC circuit 212 and a recovery data manager 214.

The ECC circuit 212 may generate ECC parity data from the write data in response to the write request from the external device 100. The ECC parity data may be stored on the storage medium 260 together with the user data. The ECC circuit 212 may check and correct errors by reading the user data and ECC parity data from the storage medium 260 in response to the read request from the external device 100.

The recovery data manager 214 may perform one or more logic operations (e.g., an XOR operation) and update the recovery data in a set unit for the write-requested user data. For example, the recovery data may include chip-kill parity data. The recovery data manager 214 stores final recovery data in the set region of the storage medium 260. The recovery data manager 214 may detect and recover from errors using the recovery data if an uncorrectable error may be generated through the ECC circuit 212 during a read operation of the user data.

In some embodiments, the controller 210 may group a plurality of memory blocks included in the first memory region of the storage medium 260 to form a block group. The controller may select a set number of memory blocks in the block group to form a sub-group. For example, the block group may include a plurality of sub-groups. In some embodiments, the plurality of sub-groups included in the block group may be sequentially opened to program data.

The controller 210 may define a plurality of page groups by grouping the pages according to a set reference among the block group. For example, the set reference may include a same identifier.

In some embodiments, the recovery data manager 214 may program the user data on the page basis for the sub-group and generate first recovery data on the page basis. The recovery data manager 214 may store the first recovery data on the page basis in the second memory region. When all of the pages in the memory blocks of the sub-group may be programmed, the recovery data manager 214 may generate second recovery data on the sub-group basis. The recovery data manager 214 may store the second recovery data in the second memory region.

Because the page groups may be distributed in different memory blocks in the memory group(s), the recovery data manager 214 may update the first recovery data associated with data programmed into selected page(s) belonging to a page group in a sub-group within a memory group, when pages belonging to the same page group in another sub-group within the same memory group are programmed.

The recovery data manager 214 may invalidate the data for the second recovery associated with the previously programmed sub-group once all of the pages of the currently programmed sub-group may be programmed.

When all of the sub-groups in the memory group may be programmed, the recovery data manager 214 may store the first recovery data on selected pages in the page group associated with the first recovery data in the first memory region.

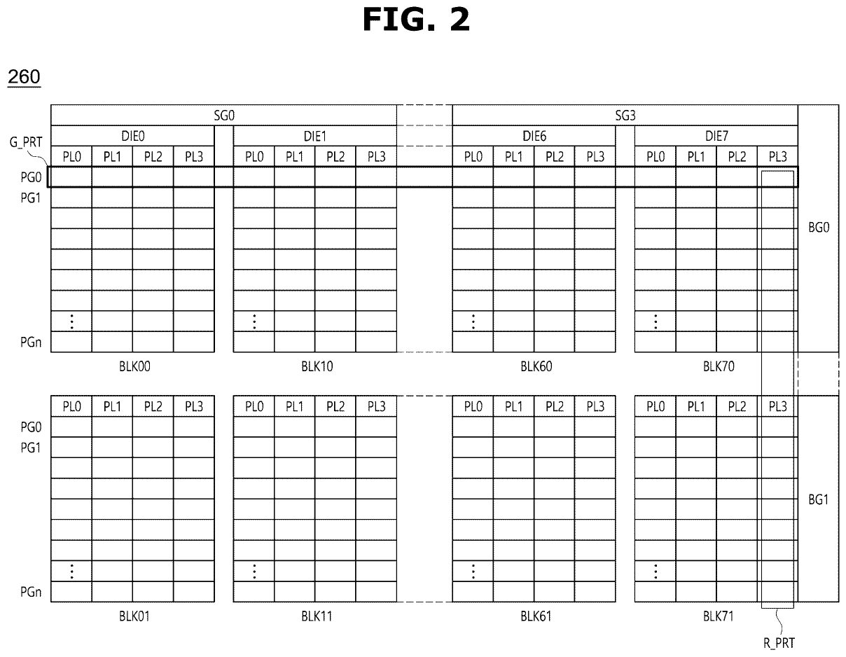

FIG. 2 is a block diagram illustrating a non-volatile memory device in accordance with embodiments.

Referring to FIG. 2, a non-volatile memory device 260 of example embodiments may include a plurality of dies DIE0, DIE1, . . . , DIE6 and DIE7. Each of the dies DIE0, DIE1, . . . , DIE6 and DIE7 may be divided into a plurality of planes PL0, PL1, PL2 and PL3. Each of the planes PL0, PL1, PL2 and PL3 may include a memory block BLK00, BLK01, BLK10, BLK11, BLK60, BLK61, BLK70 and BLK71 including a plurality of pages PG0, PG1, . . . , PGn.

The controller 210 may group selected memory blocks from each of the plurality of dies DIE0, DIE1, . . . , DIE6 and DIE7 to form a block group. For example, the controller 210 may group the memory blocks BLK00, BLK10, . . . , BLK60 and BLK70 to form a first block group BG0 and the memory blocks BLK01, BLK11, . . . , BLK61, BLK61 to form a second block group BG1.

The controller 210 may select a set number of memory blocks from each of the block groups BG0 and BG1 to form sub-groups. In some embodiments, the controller 210 may divide each of the block groups BG0 and BG1 into a given (e.g., set) number of sub-groups. For example, the controller 210 may select memory blocks BLK00 and BLK10 from the first block group BG0 to form a sub-group SG0, and memory blocks BLK60 and BLK70 from the first block group BG0 to form a sub-group SG3. The memory blocks included in the sub-groups SG0 and SG3 may be selected from different dies.

The controller 210 may form a page group by grouping selected pages from each memory block in the block group BG0 and BG1. For example, the selected pages may include the same identifier, in common.

The page groups may be referred to as a recovery group G_PRT. At least one of the pages included in the recovery group G_PRT may be selected as a recovery data storage region R_PRT. Thus, uncorrectable errors in the user data stored in the recovery group G_PRT may be recovered through recovery data stored in the recovery data storage region R_PRT.

The user data may be programmed on the page basis of sub-group. The recovery data manager 214 may generate the first recovery data on the page basis in the sub-group. When all of the pages in the sub-group may be programmed, the recovery data manager 214 may generate the second recovery data associated with all of the pages in the sub-group.

The recovery data manager 214 may perform a programming operation on the page basis for each sub-group including the block group. The recovery data manager 214 may update the first recovery data when pages of the same page group in different sub-groups are programmed. Final first recovery data may be stored in the recovery data storage region R_PRT of the associated page group. For example, the final recovery data is generated as programming of the same page groups of all sub-groups within the block group may be completed.

When all pages of the currently programmed sub-group may be programmed, the recovery data manager 214 may invalidate the second recovery data in the previously programmed sub-group.

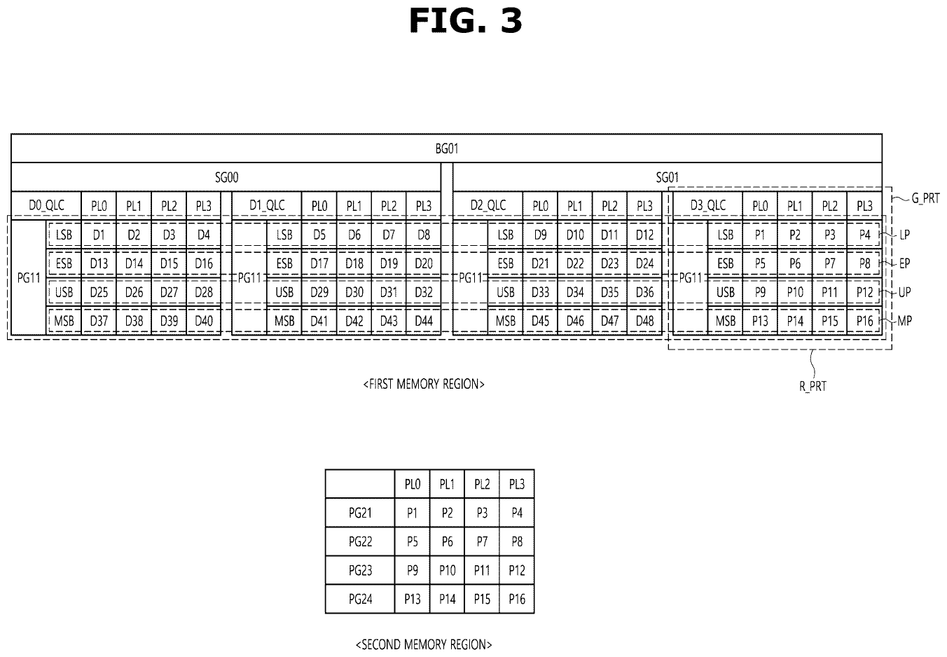

FIG. 3 is a view illustrating a data management concept for recovery based on data storage levels in accordance with embodiments.

In some embodiments, a non-volatile memory device may include a first memory region and a second memory region.

The memory cells in the first memory region may be quadruple level cells (QLC), which may store multiple bits of data, such as four bits, in a single memory cell. A QLC memory cell may logically store least significant bit (LSB) data, extra significant bit (ESB) data, upper significant bit (USB) data, and most significant bit (MSB) data.

The second memory region may include a plurality of memory cells configured to store any level of data. In some embodiments, the memory cells of the second memory region may be single level cells (SLCs).

Referring to FIG. 3, the controller 210 may select a memory block from each of the four dies D0_QLC, D1_QLC, D2_QLC and D3_QLC including memory cells operating as QLCs to form a single block group BG01, and may select two memory blocks from the block group BG01 to form two sub-groups SG00 and SG01.

Pages PG11 having the same identifier in block group BG01 may be striped to form a parity group G_PRT. For each sub-group SG00 and SG01, the user data may be programmed on LSB page LP basis, on ESB page EP basis, on USB page UP basis, and on MSB page basis, and corresponding first recovery data may be generated.

The first recovery data P1 may be generated for the user data D1 and D5 programmed into the LSB page LP of the first plane PL0 of each of the first die D0_QLC and the second die D1_QLC included in the first sub-group SG00, and the first recovery data P1 may be temporarily stored in the second memory region.

When all pages of the first sub-group SG00 may be programmed, the user data D9 may be programmed into the LSB page LP of the first plane PL0 of the third die D2_QLC included in the second sub-group SG01, and the first recovery data P1 may be updated and stored in the second memory region.

In the above manner, the LSB page LP, the ESB page EP, the USB page UP and the MSB page MP may be programmed into each plane PL1, PL2, PL3, and PL4 of each of the sub-group SG00 and SG01, to update the first recovery data P1˜P16. The final updated first recovery data P1˜P16 may be backed up to the recovery data storage region R_PRT of the first memory region.

Locations of the first recovery data generated in this process and stored in the second memory region may be managed as mapping information in a map region. When the map region may be full, the previously stored mapping information may be overwritten by new mapping information.

As the memory cells store the multiple bits of data, and as the number of memory blocks in the block group may be increased, space for storing recovery data and mapping information for the recovery data becomes more demanding, and if the recovery data may be lost or mapping information is changed, it may not be possible to recover user data from the error.

In embodiments of the present disclosure, the first recovery data on the page basis may be generated for a sub-group, stored and updated in the second memory region. The second recovery data on the sub-group basis may be generated and stored when all pages of the sub-group may be programmed.

As a result, even if the first recovery data may be lost or undetectable, error data of the sub-group may be recovered by the second recovery data.

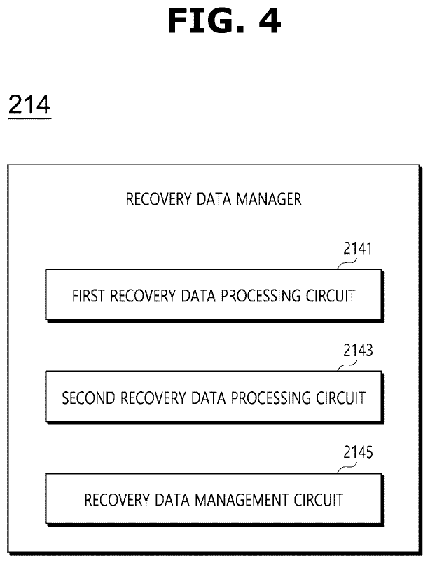

FIG. 4 is a block diagram illustrating a recovery data manager in accordance with embodiments.

Referring to FIG. 4, a recovery data manager 214 may include a first recovery data processing circuit 2141, a second recovery data processing circuit 2143, and a recovery data management circuit 2145.

The first recovery data processing circuit 2141 may generate first recovery data corresponding to the user data being programmed on a page basis for each sub-group. The first recovery data for the pages of the sub-group currently being programmed may be generated based on the user data for the pages currently being programmed and the first recovery data for the same page groups of the previously programmed sub-group.

The second recovery data processing circuit 2143 may generate the second recovery data on a sub-group basis when all pages in the sub-group may be programmed. If the block group to which the currently programmed sub-group belongs may be programmed so that no unprogrammed sub-groups exist, the second recovery data processing circuit 2143 may skip generating the second recovery data for the currently programmed (i.e., final programmed) sub-group within the block group.

The recovery data management circuit 2145 may invalidate the second recovery data for a previously programmed, completed sub-group when the second recovery data is generated by the second recovery data processing circuit 2143. The recovery data management circuit 2145 may invalidate the second recovery data for a previously programmed, completed sub-group, if no unprogrammed sub-group exist in that block group when programming of the sub-group may be complete for all of its pages.

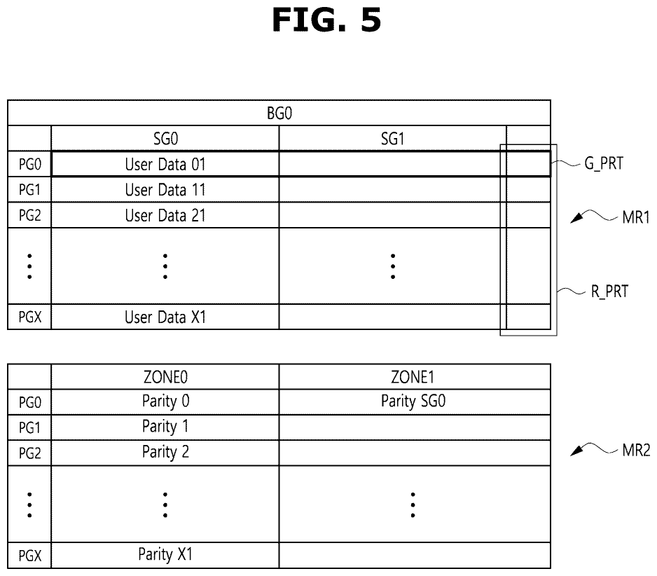

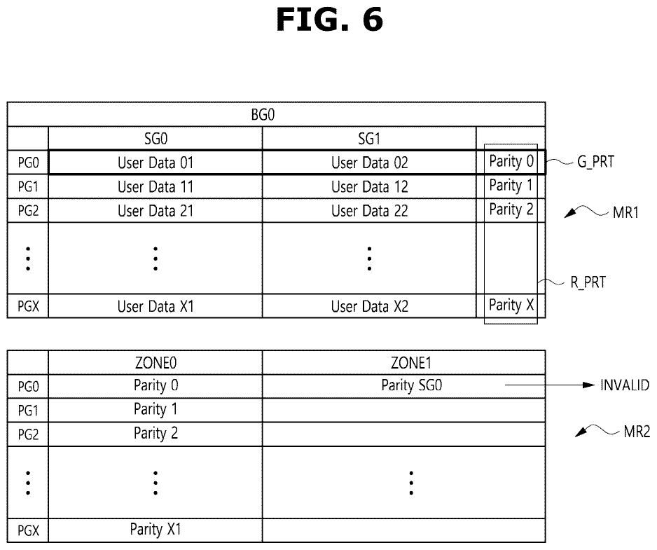

FIGS. 5 and 6 are conceptual diagrams each illustrating a method of managing data for recovery in accordance with embodiments.

FIGS. 5 and 6 illustrate a block group BG0 included in a first memory region MR1 includes a first sub-group SG0 and a second sub-group SG1, wherein each of the sub-groups SG0 and SG1 includes a plurality of pages PG0 to PGX. Pages with the same identifiers in each of the sub-groups SG0 and SG1 may include a parity group G_PRT. One sub-group in the block group BG0, e.g., the second sub-group SG1, may include a recovery data storage region R_PRT.

Referring to FIG. 5, the controller 210 may generate first recovery data Parity 0 to Parity X1 corresponding to user data User Data 01, User Data 11, User Data 21 and User Data X1 of the first sub-group SG0 and store the first recovery data in a first zone ZONE0 of the second memory region MR2. For example, the user data User Data 01, User Data 11, User Data 21 and User Data X1 may be programed on the page basis. In some embodiments, the controller 210 may generate first recovery data Parity 0 to Parity X1 programed on a page basis to respectively correspond to data User Data 01 to User Data X1 programmed in the first sub-group on the page basis. For example, a plurality portions of the data User Data 01 to User Data X1 may be programmed in a plurality of pages PG0 to PGX of the first sub-group SG0, respectively, and each of a plurality of portions of the first recovery data Parity 0 to Parity X1 is parity data associated with a corresponding one of the plurality of portions of the data User Data 01 to User Data X1 programmed in the first sub-group SG0.

When all pages of the first sub-group SG0 may be programmed, the controller 210 may generate second recovery data ‘Parity SG0’ for the first sub-group SG0 and store the second recovery data in a second zone ZONE1 of the second memory region MR2. In some embodiments, the controller 210 may generate second recovery data Parity SG0 programed on a sub-group basis for the first sub-group SG0 when programming of the first sub-group SG0 is complete.

Referring to FIG. 6, the controller 210 may update the first recovery data Parity 0 to Parity X associated with the user data User Data 02, User Data 12, User Data 22 and User Data X2 programmed on the page basis in the second sub-group SG1 after all pages in the first sub-group SG0 may be programmed. In some embodiments, the controller 210 may update the first recovery data Parity 0 to Parity X1 to respectively correspond to data User Data 02 to User Data X2 programmed in the second sub-group SG1 on the page basis.

Since all sub-groups SG0 and SG1 of block group BG0 are programmed, the controller 210 may back up the updated final first recovery data Parity 0 to Parity X to the recovery data storage region R_PRT. In some embodiments, the controller 210 may back up the updated first recovery data Parity 0 to Parity X to the recovery data storage region R_PRT in the first memory region MR1, when the second sub-group SG1 is a last sub-group in the block group BG0 to be programmed and programing of the block group BG0 is complete.

When all pages of the second sub-group SG1 may be programmed, the controller 210 may invalidate the second recovery data ‘Parity SG0’ for the first sub-group SG0, which is the previously programmed sub-group. For example, mapping information for the second recovery data ‘Parity SG0’ may be invalidated. In some embodiments, the controller 210 may invalidate the second recovery data Parity SG0 for the first sub-group SG0 when programming of the second sub-group SG1 is complete. The second sub-group SG1 is programmed after the programming of the first sub-group SG0 is complete.

The controller 210 may not generate data for the second recovery data for the second sub-group SG1 because no unprogrammed sub-group exists in the block group B0. In some embodiments, the controller 210 may skip generation of the second recovery data for the second sub-group SG1 when the second sub-group SG1 is a last sub-group in the block group BG0 to be programmed.

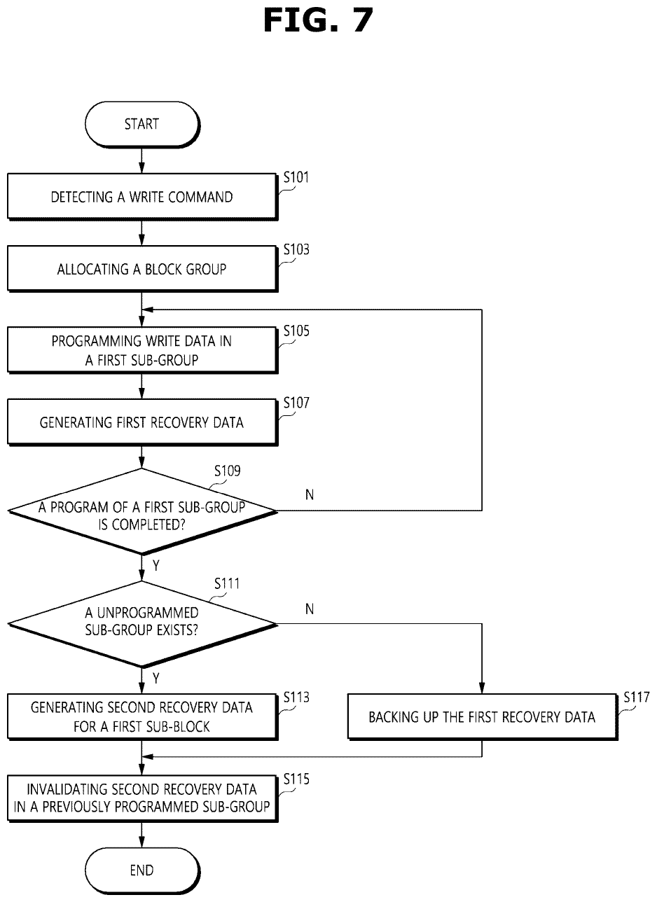

FIG. 7 is a flow diagram illustrating a method of operating a data storage device in accordance with embodiments.

Referring to FIG. 7, the controller 210 may detect a write command (S101) by an internal operation of the external device 100 or the data storage device 200, and allocate a block group to program write data in the first memory region, based on a detecting result (S103).

The controller 210 may open the first sub-group of the allocated block group to program write data on a page basis (S105).

The controller 210 may generate first recovery data on the page basis of the first sub-group and store the first recovery data in the second memory region (S107).

The controller 210 may verify that all pages in the first sub-group are programmed (S109). If any unprogrammed page exists (S109:N), the controller 210 may program the write data into the first sub-group (S105). When all pages of the first sub-group are programmed (S109:Y), the controller 210 may determine if any unprogrammed sub-group exists within that block group (S111).

If the unprogrammed sub-group exists within the block group including the first sub-group (S111:Y), the controller 210 may generate second recovery data for the first sub-group and store the second recovery data in the second memory region (S113). Further, the second recovery data for a previously programmed sub-group may be invalidated (S115).

On the other hand, if the unprogrammed sub-group does not exist within the block group including the first sub-group (S111:N), the controller 210 may back up the first recovery data stored in the second memory region to the first memory region (S117) and invalidate the second recovery data for the previously programmed sub-group (S115).

Because the second recovery data as well as the first recovery data per page may be stored, errors of the user data may be recovered based on the second recovery data, even if the page-specific recovery data may be lost or not detected.

As such, those skilled in the technical field to which the present disclosure belongs will understand that embodiments of the present disclosure may be implemented in other specific forms. It should therefore be understood that the embodiments described above are examples and are not intended to be limiting. Modifications or variations of the above-described embodiments are possible.

What is claimed is:

1. A data storage device comprising:
a memory device including a plurality of memory blocks; and
a controller configured to control the memory device,
wherein the controller divides a block group including the memory blocks into a set number of sub-groups, the sub-groups including first and second sub-groups, each of the sub-groups including a plurality of pages, and
wherein the controller generates first recovery data programed on a page basis to correspond to data programmed in the first sub-group on the page basis, generates second recovery data programed on a sub-group basis for the first sub-group when programming of the first sub-group is complete, and invalidates the second recovery data for the first sub-group when programming of the second sub-group is complete, the second sub-group being programmed after the programming of the first sub-group is complete.

2. The data storage device of claim 1, wherein the controller is configured to manage the memory device as a first memory region and a second memory region, allocate the block group in the first memory region, and store the first and second recovery data in the second memory region.

3. The data storage device of claim 2, wherein the controller is configured to update the first recovery data to correspond to data programmed in the second sub-group on the page basis.

4. The data storage device of claim 3, wherein the controller is configured to back up the updated first recovery data to the first memory region when the second sub-group is a last sub-group in the block group to be programmed and programing of the block group is complete.

5. The data storage device of claim 1, wherein the controller is configured to skip generation of the second recovery data for the second sub-group when the second sub-group is a last sub-group in the block group to be programmed.

6. The data storage device of claim 1, wherein a plurality portions of the data are programmed in the plurality of pages of the first sub-group, respectively, and
wherein each of the plurality portions of the first recovery data is parity data associated with a corresponding one of the plurality of portions of the data programmed in the first sub-group.

7. A data storage device comprising:
a memory device including a block group, the block group including a plurality of sub-groups, the plurality of sub-groups including first and second sub-groups; and
a controller configured to generate first recovery data programmed based on a unit to correspond to data programmed in the first sub-group based on the unit, generate second recovery data for the first sub-group when programming of the first sub-group is complete, and to invalidate the second recovery data for the first sub-group when programming of the second sub-group is complete, the second sub-group being programmed after the programming of the first sub-group is complete.

8. The data storage device of claim 7, the controller is configured to manage the memory device as a first memory region and a second memory region, allocate the block group in the first memory region, and store the first and second recovery data in the second memory region.

9. The data storage device of claim 8, wherein the controller is configured to update the first recovery data to correspond to data programmed in the second sub-group based on the unit.

10. The data storage device of claim 9, wherein the controller is configured to back up the updated first recovery data to the first memory region when the second sub-group is a last sub-group in the block group to be programmed and programing of the block group is complete.

11. The data storage device of claim 7, wherein the controller is configured to skip generation of the second recovery data for the second sub-group when the second sub-group is a last sub-group in the block group to be programmed.

12. The data storage device of claim 7, wherein the unit is a page.

13. A method of operating a data storage device, wherein the data storage device includes a memory device and a controller, the memory device includes a plurality of memory blocks, a block group with the plurality of memory blocks includes a set number of sub-groups, the sub-groups includes first and second sub-groups, each of the sub-groups including a plurality of pages, and the controller is configured to control the memory device, the method comprising:
generating, by the controller, first recovery data programmed on a page basis of to correspond to data programmed in the first sub-group;
generating, by the controller, second recovery data programmed on a sub-group basis for the first sub-group when programming of the first sub-group is complete; and
invalidating, by the controller, the second recovery data for the first sub-group when programming of the second sub-group is complete, the second sub-group being programmed after the programming of the first sub-group is complete.

14. The method of claim 13, further comprising:
managing, by the controller, the memory device as a first memory region and a second memory region;
allocating the block group in the first memory region; and
storing the first and second recovery data in the second memory region.

15. The method of claim 14, further comprising:
updating, by the controller, the first recovery data to correspond to data programmed in the second sub-group on the page basis.

16. The method of claim 15, further comprising backing up, by the controller, the updated first recovery data to the first memory region when the second sub-group is a last sub-group in the block group to be programmed and programming of the block group is complete.

17. The method of claim 13, further comprising: skipping generation of the second recovery data for the second sub-group when the second sub-group is a last sub-group in the block group to be programmed.

18. The method of claim 13, wherein a plurality portions of the data are programmed in the plurality of pages of the first sub-group, respectively, and
wherein each of the plurality portions of the first recovery data is parity data associated with a corresponding one of the plurality of portions of the data programmed in the first sub-group.
